(19) United States
(12) Patent Application Publication
(10) Pub. No.: US 2011/0030576 A1
(43) Pub. Date: Feb. 10, 2011

(54) Modular wet room for rail vehicles

(76) Inventors: Claudio Cipone, Wien (AT); Martin Kronabeter, Freundorf (AT)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/936,400

(22) PCT Filed: Nov. 17, 2008
(86) PCT No.: PCT/EP08/65653

§ 371 Date: Oct. 5, 2010

(30) Foreign Application Priority Data
Apr. 23, 2008 (AT) A642/2008

(51) Int. Cl. B61D 35/00; B32B 3/30; B32B 3/06; B32B 3/00

(52) U.S. Cl. 105/397; 428/156; 428/99; 428/603

(57) ABSTRACT

A modular wet room for rail vehicles is provided. The wet room includes floor elements, wall elements and ceiling elements composed of core composite material and connected among each other using connection profiles. Supply and discharge lines run along reinforcement profiles integrated into the panels. Further, a panel and a corner profile are provided.

### CROSS REFERENCE TO RELATED APPLICATIONS

This application is the US National Stage of International Application No. PCT/EP2008/065653 filed Nov. 17, 2008, and claims the benefit thereof. The International Application claims the benefits of Austrian Application No. A642/2008 AT filed Apr. 23, 2008. All of the applications are incorporated by reference herein in their entirety.

### FIELD OF INVENTION

The invention relates to a modular wet room for rail vehicles.

### BACKGROUND OF INVENTION

Wet rooms in rail vehicles usually include a washbasin, a toilet, a shower, and various accessories such as mirrors, fixings for lavatory paper and paper-towel dispensers, and fixings for a lavatory brush, electric warm-air hand-dryers, soap dispensers, and suchlike. Supply companies typically deliver said wet rooms as a prefabricated unit to the rail-vehicle manufacturer, who installs them as a single piece while assembling the rail vehicle.

The commonest way to embody wet rooms for rail vehicles is to construct them from glass fiber reinforced plastic (GFRP), typically employing a metallic reinforcing skeleton. They are constructed in the manner customary for GFRP structures using a mold into which layers of glass fiber tissue are laid then soaked in hard-setting liquid plastic (epoxy or polyester resin) and removed from said mold after setting. A possibly provided metallic reinforcing skeleton can with that production method be integrated into the GFRP structure. It is a method generally employed for producing plastic components having a large area or volume, for example for boat bodies and structures, vehicles, and small aircraft. Integrated wet rooms for hotels are also produced employing the same production method.

The specific approval requirements applying to rail vehicles necessitate subjecting every material used in rail vehicles to specific checks, with particular requirements being placed especially on how the materials behave in fire. Those testing and approval processes have to be repeated whenever any of the materials used in said wet rooms are changed. That makes it much more difficult, for example, to change the manufacturer of a wet room because different manufacturers usually employ different starting materials (glass fiber mats, resins, and hardening agents). So even with no change to the mechanical design, the production of a particular type of wet room is virtually tied to one manufacturer because the expenditure in terms of time and money of repeating the approval checks makes that an uneconomical approach.

It is a major disadvantage of said wet rooms produced according to the described construction method that a separate mold also has to be produced for each variant when adaptations and modifications are made (integrating into a different type of vehicle, for instance, or changing the fittings), quite apart from the effort and cost involved in changing the design. Adapting quickly to customers' wishes is made far more difficult as a result and will entail significant cost and effort.

Also the weight of GFRP wet rooms is very high, with its being particularly disadvantageous that the GFRP production process produces components that do not have satisfactorily constant characteristics owing also to the high percentage of manual work. Substantial differences in the weight of individual wet rooms arise particularly because of wall thicknesses that vary from specimen to specimen. The high weight adversely affects further handling, particularly during transportation from the wet-room manufacturer to the rail-vehicle manufacturer and during installation into the rail vehicles. Individual specimens of wet rooms will naturally have different mechanical strengths owing to the different wall thicknesses, or the variability in strength will have to be counteracted by employing structural means to increase the wall thicknesses.

Wet rooms produced by the described method will furthermore require substantial cost and effort to repair if damaged. Small-scale damage as commonly caused by vandalism can be repaired with the wet room still installed in the rail vehicle. Larger-scale damage such as results from a fire or massive vandal attack will require the wet room to be replaced. That is possible only by detaching any parts of the rail vehicle that impede dismounting and by removing a component (typically an end wall, or parts of the outer wall or of the roof) of the rail vehicle. Even if breaking up a badly damaged wet room inside the carriage will enable the pieces of relevant parts to be removed, a new wet room cannot be installed without removing a component of the rail vehicle.

### SUMMARY OF THE INVENTION

An object of the invention is to disclose a modular wet room for rail vehicles that does not have the disadvantages of the solutions according to the prior art and in particular will not necessitate any disassembling of the affected rail vehicle if repairs are needed.

The object is achieved by a wet room as claimed in the independent claim. Advantageous embodiments are the subject matter of dependent claims.

In keeping with the basic idea underlying the invention, what is described is a wet room for rail vehicles that is made of individual panels forming the wet room's floor, walls, and ceiling.

No support structure of whatever kind is needed for constructing an inventive wet room.

The panels consist of a light material approved for use in rail vehicles (for example what is termed core composite or sandwich material consisting of, for instance, an aluminum honeycomb structure planked with high-pressure laminate) and joined to each other and to the rail vehicle itself by means of metal profiles (typically aluminum profiles).

Any core composite material approved for use in rail vehicles is suitable for employing as a sandwich material. Alongside a sandwich material having an aluminum honeycomb structure planked with high-pressure laminate it is possible also to use, for example, polypropylene structures or polystyrene foams planked with high-pressure laminate. The sandwich material can also be planked using GFRP.

Alongside their inner (honeycomb) structure and double-sided planking, the panels include edge strips consisting of metal profiles by means of which the panels are joined to each other and to the rail vehicle.

The panels are joined to each other using the customary means known from the general use of core composite materials. What are typically employed for the purpose are tongue-and-groove joints combined with a screw connection.

The panels are joined to the rail vehicle typically using vibration-damping rubber/metal elements.

Metal profiles can be used to cover the individual panels' abutting edges. The dimensions of the panels can be freely selected and are limited only by the dimensions of the raw material itself and technical production-related factors. It is advantageous to choose a size for the panels allowing them to be transported through the openings in the rail vehicle (doors, windows).

The necessary lines (for example electric lines, water and waste lines, warm-air lines, pneumatic lines, etc.) are inventively integrated in the panels while those are being produced, with said lines being fitted into recesses in the inner part (for example the aluminum honeycomb structure) of the sandwich material.

In certain applications, particularly when a specific panel has no visible surfaces (ones that are exposed during use and on which esthetic requirements are placed), lines can also be mounted on said (non-visible) surface of the panel. That has the advantage of not having to fit lines into panels of such type.

The inventive solution will enable wet rooms for rail vehicles to be constructed that can be matched to all kinds of mounting situations with no changes to tools for producing them (typically molds for GFRP production). The modification effort to be expended when another variant is designed is the only requirement. Only conventional tools and equipment for producing and processing core composite materials are needed to produce inventive wet rooms and no molds whatever for GFRP production.

Using materials approved for rail vehicles will enable a multiplicity of variants of the wet rooms to be produced without needing to repeat the costly and effort-intensive approval tests. It is therein particularly advantageous to employ non-flammable materials.

The use of panels (made of sandwich elements) is advantageous because customers' requirements can be better met by varying the surface in term's of its color and structure and it will still be possible to efficiently produce a multiplicity of variants. It is provided for the panels to be fitted with the installations (water, waste, air, hydraulic, or electric lines) and accessories (minors, for example) necessary for the wet rooms. Fitting said installations and accessories will be greatly facilitated thereby as it can be done outside the rail vehicle. The pipework for water and waste lines is likewise installed in said panels while they are being produced, as are the electric and all other lines.

A wet room constructed according to the inventive system advantageously includes a panel that concentrates all the wet room's connections (typically for water, waste, and electricity) at a single location where the connection to the rail vehicle's line system is also made.

The wet room can be assembled (typically when new rail vehicles are being constructed) outside the rail vehicle and the wet room can hence be fitted as a complete unit, which is advantageous for new constructions because the rail vehicle's covering (end walls, roof, etc.) will in that case not have been closed yet. The advantage of being able to repair the wet room (in the case of more serious damage, say) in its installed condition, meaning without removing the rail vehicle's end walls, for instance, is a major advantage of the inventive system. Damaged panels can be detached and, owing to their dimensions, passed through the openings in the rail vehicle (doors, windows) so that a wet room can be repaired in far less time and so more cheaply.

It is equally advantageous to construct the wet room inside the rail vehicle because the production flow can then be designed such that all other operations, particularly sealing the rail vehicle's covering, can be performed first and the work required for fitting the wet room can be carried out in another production plant, for example.

Another major advantage of an inventive wet room is that even if the production flow scheduled for the rail vehicle requires that the wet room be fitted in one go, a wet room possibly not present at the time scheduled for fitting it will not hinder the further installation work to be carried out on the rail vehicle because the wet room can be retrofitted at any time even if the rail vehicle's covering has been closed.

An embodiment variant of the panels provides for them to be joined to each other using a tongue-and-groove joint. They can further more be joined also by means of an adhesive join, in which case the capability of being disassembled is an advantage that will cease to apply.

The most important advantage of the inventive system is the significant reduction in the wet room's weight. The panels employed in a structure of sandwich design have a significantly lower specific weight than conventional designs having the same mechanical strength. A 30% weight saving can typically be achieved compared with a conventional structural design. Said weight saving is on the one hand advantageous when the rail vehicle is operating because smaller masses have to be accelerated and decelerated; on the other hand the lower weight will impact on the entire production process (particularly when the wet room is being transported and fitted).

What is also advantageous is that panels (especially panels having a metallic honeycomb or foam structure) can be reused (recycled).

It is also advantageous that applying this invention will enable rail vehicles (not having wet rooms) to be retrofitted with wet rooms and (conventional) wet rooms in rail vehicles already in use to be easily replaced.

The inventive wet room is not limited to applications in which water or waste lines are used; also included are applications requiring only, for example, electric lines such as, say, in the construction of diaper-changing rooms, conductors' compartments, luggage rooms, and suchlike.

### BRIEF DESCRIPTION OF THE DRAWINGS

By way of example:

FIG. 1 shows the basic structure of a panel made of core composite material having integrated lines.

FIG. 2 shows the basic structure of a join between two panels.

FIG. 3 shows the basic structure of a join between wall and floor panels.

FIG. 4 shows the basic structure of an inventive wet room in a rail vehicle.

FIG. 5 shows the basic structure of a panel made of core composite material.

### EMBODIMENT OF THE INVENTION

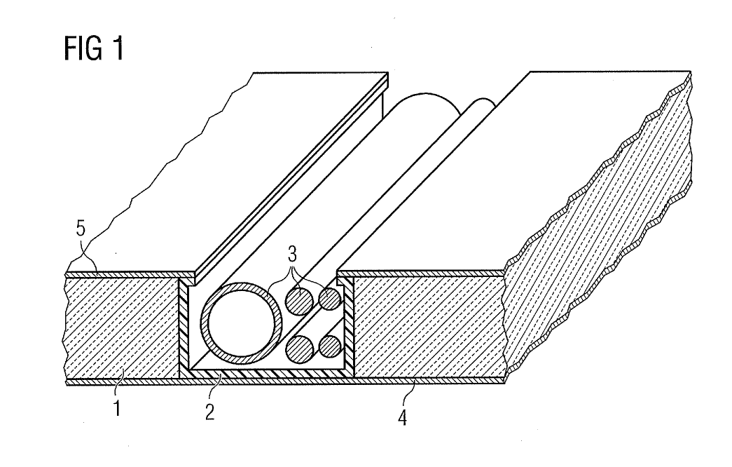

FIG. 1 shows by way of example and schematically the basic structure of a panel made of core composite material having integrated lines. The panel has a three-layered structure comprising a top facing 5, a core material 1, and a bottom facing 4. Top and bottom facings 5 and 4 can have different colors and surface structures to match them to the respective functional purpose or to the design of the vehicle's other surroundings. Core material 1 consists of, for example, aluminum honeycomb material and top and bottom facings 5 and 4 consist of, for example, high-pressure laminate. Inserted into a recess of core material 1 is a closed reinforcing profile 2 (flat tube) having the same thickness as core material 1, as a consequence of which scarcely a reduction in the panel's mechanical strength can occur at the reinforcing profile's location. Reinforcing profile 2 is fabricated typically from aluminum. The reinforcing profile's location is shown in cross-section in FIG. 1. Lines 3 are ducted in reinforcing profile 2; shown schematically in FIG. 1 are a pipeline and three electric lines. Said lines are ducted at the requisite places on the panel through openings in reinforcing profile 2 and in either top facing 5 or bottom facing 4 to the required location (an electric lamp, for example).

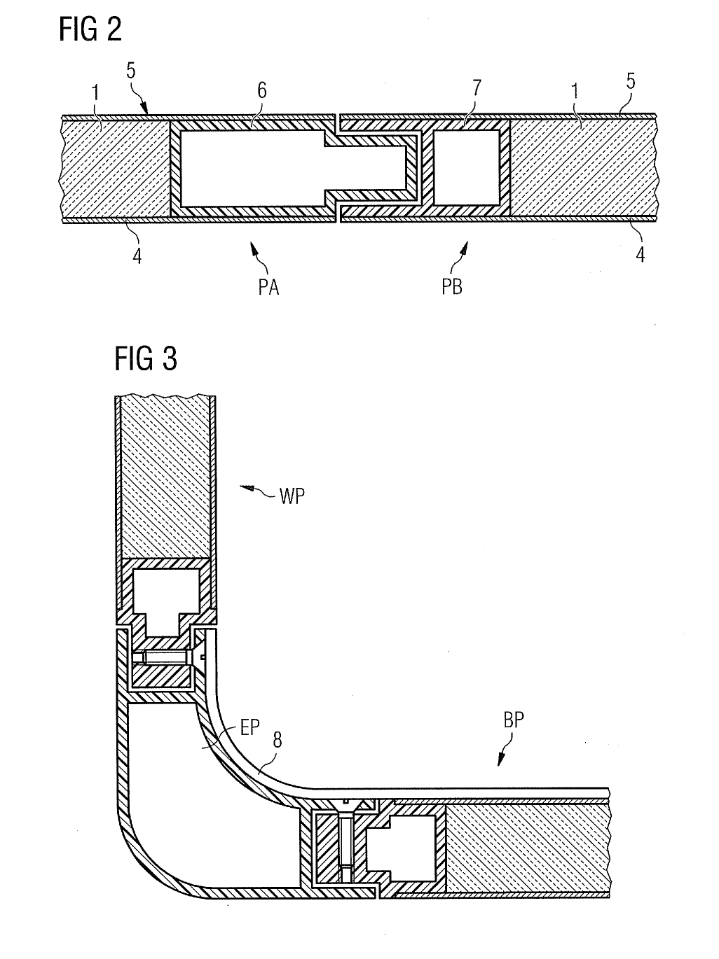

FIG. 2 shows by way of example and schematically the basic structure of a join between two panels, typically two wall panels. A first panel PA having a layered structure consisting of a core material 1 and in each case a top and bottom facing 4, 5 is fitted where joined to a second panel PB with a connecting profile A. The second panel PB has the same layered structure consisting of a core material 1 and in each case a top and bottom facing 4, 5 and is fitted where joined to panel PB with a connecting profile B. Connecting profiles A, B have the same thickness as core material 1, as a consequence of which scarcely a reduction in the panel's mechanical strength can occur at the edges of the panel either; the strength values will instead even be reinforced by a possibly developing frame structure formed from connecting profiles. Connecting profiles A, B are, like reinforcing profiles 2, joined to top and bottom facings 4, 5 and core material 1 when the panel is being produced. Connecting profiles A, B have a tongue-and-groove joint and are detachably joined to each other by means of a screw connection (not shown in FIG. 2). The screw connection can be provided perpendicular to or in the plane of the panel. For a screw connection in the plane of the panel the connecting profile of one of the panels is provided with a tapped hole and the other panel with a recess in at least one of facings 4, 5 and in said panel's connecting profile through which hole a screw can be passed and through which recess the screw head can be accessed. It is optionally provided for the butt joint between two panels to be covered by a metal cover profile (not shown in FIG. 2), with its being possible for said cover profile to be embodied such as also to cover the openings for actuating the screw head.

FIG. 3 shows by way of example and schematically the basic structure of a join between a floor panel and a wall panel. Joins between wall panels and ceiling panels and all edges in a wet room are implemented according to the same method.

A corner profile EP, typically of aluminum, has receiving places into which the corresponding connecting profiles of the wall panel WP and floor panel BP are inserted and detachably joined to each other by means of a screw connection (tongue-and-groove joint). Shown in FIG. 3 by way of example is a screw connection perpendicular to the respective plane of the panel. A floor covering 8 has been put onto the floor panel BP and is taken on the wall panel as far as the top edge of the corner profile EP and typically glued to the corner profile EP. An even transition can be achieved at the seam between floor covering 8 and the wall profile by appropriately selecting the thicknesses of the wall profile WP and the floor covering 8.

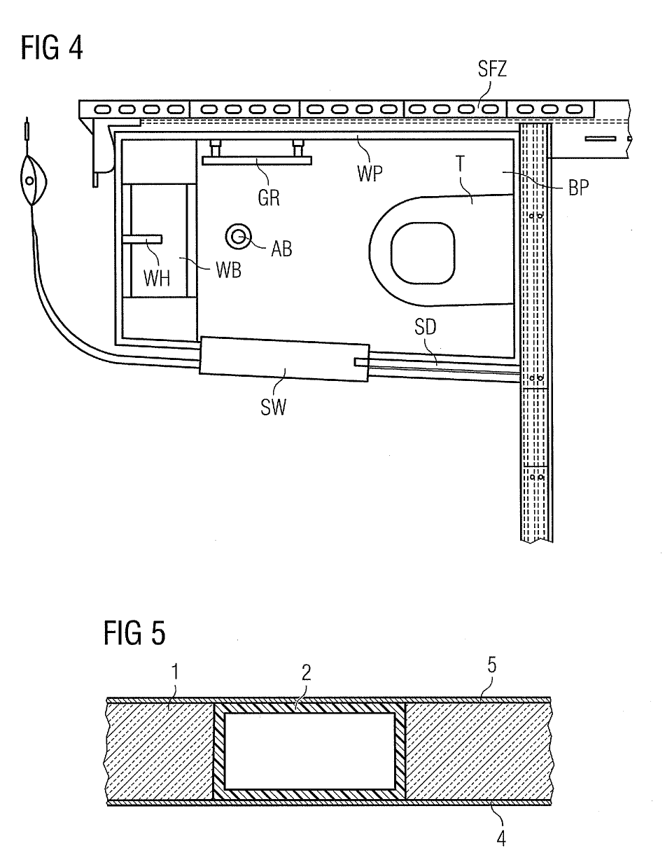

FIG. 4 shows by way of example and schematically the basic installation of a wet room in a rail vehicle. A wet room consisting of wall panels WP, floor panels BP, and ceiling panels (not shown) is at a suitable place secured to the structure of the rail vehicle SFZ. Not shown in FIG. 4 are the joints between individual wall panels WP (see FIG. 2). The wet room includes by way of installations a toilet T, a washbasin WB, a faucet WH, a handlebar GR, and a drain AB. The entrance to the wet room is covered on the floor side with a threshold SW typically of metal. A sliding door SD is mounted in a double-walled structure made of wall panels WP. Further installations typically found in wet rooms such as lights, electric switches, outlets of warm-air lines of hand-dryers are not shown.

FIG. 5 shows by way of example and schematically the basic structure of a panel. The panel has a three-layered structure comprising a top facing 5, a core material 1, and a bottom facing 4. Inserted into a recess of core material 1 is a closed reinforcing profile 2 (flat tube) having the same thickness as core material 1. Lines ducted through reinforcing profile 2 are not shown in FIG. 5.

1.-4. (canceled)

5. A modular wet room for rail vehicles, comprising:
wall elements made of core composite material;
floor elements made of core composite material; and
ceiling elements made of core composite material,
wherein supply and discharge lines are built into the wall elements, floor elements and ceiling elements made of core composite materials.

6. A panel, comprising:
core composite materials, the panel being used as a wall element, floor element or ceiling element for a wet room of a rail vehicle,
wherein supply and discharge lines are ducted in reinforcing profiles located in recesses of the core materials.

7. The panel as claimed in claim 6, further comprising:
a tongue-and-groove joint detachably secured by a screw connection for joining the panel to another wall, floor, or ceiling element.

8. A corner profile comprising metal for joining wall elements, floor elements or ceiling elements for a wet room of a rail vehicle in an angled manner, wherein the corner profile has a tongue-and-groove joint into which the corresponding connecting profiles of the wall, floor, or ceiling elements are inserted and detachably secured by a screw connection.
